(19) United States
(12) Patent Application Publication
(10) Pub. No.: US 2025/0371059 A1
(43) Pub. Date: Dec. 4, 2025

(54) ARTIFICIAL INTELLIGENT RECOMMENDATIONS FOR SYSTEM CREATION AND MANAGEMENT

(71) Applicant: Shopsense, Inc., Redwood City, CA (US)

(72) Inventors: Gavin Simpson, Redwood City, CA (US); Dharmil Chandarana, Redwood City, CA (US); Tabrez Mohammed, Redwood City, CA (US); Samuel Gottlieb, Redwood City, CA (US)

(21) Appl. No.: 19/222,535

(22) Filed: May 29, 2025

Related U.S. Application Data
(60) Provisional application No. 63/653,081, filed on May 29, 2024.

(51) Int. Cl. G06F 16/335; G06F 9/451

(52) U.S. Cl. CPC G06F 16/335; G06F 9/451

(57) ABSTRACT

Methods and systems for generating content recommendations using AI models are disclosed herein. In some embodiments, the method includes receiving user input. The method includes converting the user input into a high-dimensional embedding using one or more AI models. The method also includes performing a hierarchical search using the high-dimensional embedding to retrieve and refine a search result of recommended items and presenting the recommended items to a user.

### CROSS REFERENCE TO RELATED APPLICATION

This application claims the benefit of U.S. Provisional Patent Application No. 63/653,081, titled “Artificial Intelligent Recommendation System for Store Creation and Management,” and filed on May 29, 2024, the entire content of which is incorporated by reference herein.

### TECHNICAL FIELD

This disclosure relates to artificial intelligence (AI) technique, in particular, to automatically generating content recommendations using AI model(s) to enhance system creation and management processes.

### BACKGROUND

An affiliate network that connects people (e.g., publishers, advertisers, agencies) together to grow online business is proven to be extremely useful in driving the success of an e-commerce campaign. To start the affiliate strategy, a publisher needs to set up a website or store and partner with brands (e.g., by signing up for affiliate networks/programs with the brands) to promote their products or services. The building of this website or online store is therefore critical. For example, common mistakes such as picking the wrong products or services, promoting too many or low-quality products, ignoring the quality of store content, lacking workable mechanisms to track or analyze data, etc., should be avoided. Dealing with these issues can be challenging, especially when a massive amount of comprehensive product and service information is obtained from heterogeneous sources.

Systems that rely on multi-party integration and user-defined setup, such as platforms that connect multiple participants or services, require careful initial configuration to function effectively. System performance depends not only on the quality of the core platform but also on how external components (e.g., products, services, data sources, or application programming interfaces (APIs)) are selected, organized, and managed. Poor setup choices or lack of operational insight can lead to inefficiencies, errors, or underperformance, especially when dealing with large volumes of unstructured or heterogeneous data. For example, building and configuring online stores to avoid issues such as poor product selection or insufficient data analytics is important in e-commerce, just as preventing misconfigurations in a cloud-based platform is essential for maintaining system performance and security.

Hence, an approach that provides a recommendation and search tool to facilitate system creation and management is desirable.

### SUMMARY

To address the aforementioned shortcomings, a method and a system for generating content recommendations using AI models are disclosed herein. In some embodiments, the method includes receiving user input. The method includes converting the user input into a high-dimensional embedding using one or more AI models. The method also includes performing a hierarchical search using the high-dimensional embedding to retrieve and refine a search result of recommended items and presenting the recommended items to a user.

In some embodiments, to perform the hierarchical search, a first search is performed on a database to retrieve a set of content items based on measuring similarity between the high-dimensional embedding and embeddings of items stored in the database. The set of content items is refined by performing a second search on the set of content items based on at least one of a type of the user input or a number of the user input. A third search is performed on the refined content items to determine the search result of recommended items using a parameterized algorithm operating in a continuous learning environment. In some embodiments, contextual information associated with the user input is identified, and the identified contextual information is appended to the user input. Both the user input and the appended information are converted into the high-dimensional embedding. In some embodiments, the search result of recommended items includes a first item and a second item, and the first item is presented to the user before the second item. The second item is dynamically updated based on user interaction with the first item. In some embodiments, one or more user permissions and roles are determined for the user, and an identity of the user is verified based on the user permissions and roles. In some embodiments, a customized landing page is provided to the user based on the user permissions through a graphical user interface, and one or more interactive elements are added in the graphical user interface to receive the user input from the user. In some embodiments, multiple shuffles are created to provide dynamic content.

In some embodiments, the user input includes one or more of an image, a text input, a categorical filter, or a voice input. In some embodiments, the hierarchical search comprise one or more of an image-to-image retrieval, an image-to-text retrieval, a text-to-image retrieval, or a text-to-text retrieval. In some embodiments, the one or more AI models include a customized transformer-based multi-modal embedding model.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The disclosed embodiments have advantages and features that will be more readily apparent from the detailed description, the appended claims, and the accompanying figures (or drawings). A brief introduction of the figures is below.

FIG. 1 illustrates an exemplary block diagram of the overall architecture of the present system, according to some embodiments.

FIG. 2 illustrates exemplary components of a recommendation system described herein, according to some embodiments.

FIG. 3 illustrates an exemplary flowchart of generating content recommendations using AI models, according to some embodiments.

FIG. 4 illustrates a block diagram of an example computer system that may be used in implementing the technology described herein, according to some embodiments.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

It is challenging to ensure high-quality setup and integration in dynamic environments where inputs (e.g., services, products, APIs) are numerous and heterogeneous. An affiliate network that connects people (e.g., publishers, advertisers, agencies) together to grow online business plays a significant role in e-commerce success, but effectively launching a campaign requires publishers to set up a website or store and partner with brands (e.g., by signing up for affiliate networks/programs with the brands) to promote their products or services. The building of this website or online store is critical. For example, common mistakes such as picking the wrong products or services, promoting too many or low-quality products, ignoring the quality of store content, lacking workable mechanisms to track or analyze data, etc., should be avoided.

In a cloud-based application orchestration platform, microservices are deployed using containerized environments and utilized by multiple entities (e.g., developers, service providers, monitoring tools, etc.). Developers may configure their applications by selecting appropriate container images, allocating resources, connecting to external APIs, and integrating monitoring and security tools. However, mistakes such as selecting outdated libraries, misconfiguring resource limits, or failing to implement logging and observability can severely affect performance and security.

In these systems, whether for online store creation and management or cloud-based application configuration and administration, choosing appropriate components (e.g., third-party components) and managing inconsistent or low-quality external data are challenging. Another common issue is the lack of feedback or monitoring tools to evaluate configuration/creation effectiveness. These problems are exacerbated when systems (e.g., products, microservices) rely on diverse, inconsistent, and/or rapidly changing external sources.

### System Overview

The present disclosure proposes an intelligent recommendation system that assists with the setup, configuration, and validation of integrated components of various platforms. While the description hereafter focuses mainly on an e-commerce affiliate network or a cloud deployment platform, it should be noted that the approach described herein can be applied to a wide range of fields such as streaming services, education and e-learning platforms, healthcare and diagnostics, smart assistant and internet of thing (IoT) devices, etc.

In some embodiments, the present system may be powered by AI techniques to generate and provide content (e.g., product, application) recommendations and insights. This recommendation system can enable store creation based on publishers' requirements and facilitates store management by publishers. For example, one or more AI models/algorithms may be applied to enhance the store creation process by (1) finding similar items and (2) recommending products based on user input. The user input may include one or more text, image/video, or voice prompts. When applied to generate and deliver recommendations and insights for application configuration and deployment in a cloud-based environment, this intelligent recommendation system can assist developers in setting up application environments based on project requirements and facilitate ongoing management and optimization. For example, one or more AI models/algorithms may be employed to enhance the deployment process by identifying relevant microservices or container images and recommending infrastructure configurations based on user input. The user input may include one or more textual descriptions, code snippets, diagrams, or voice commands.

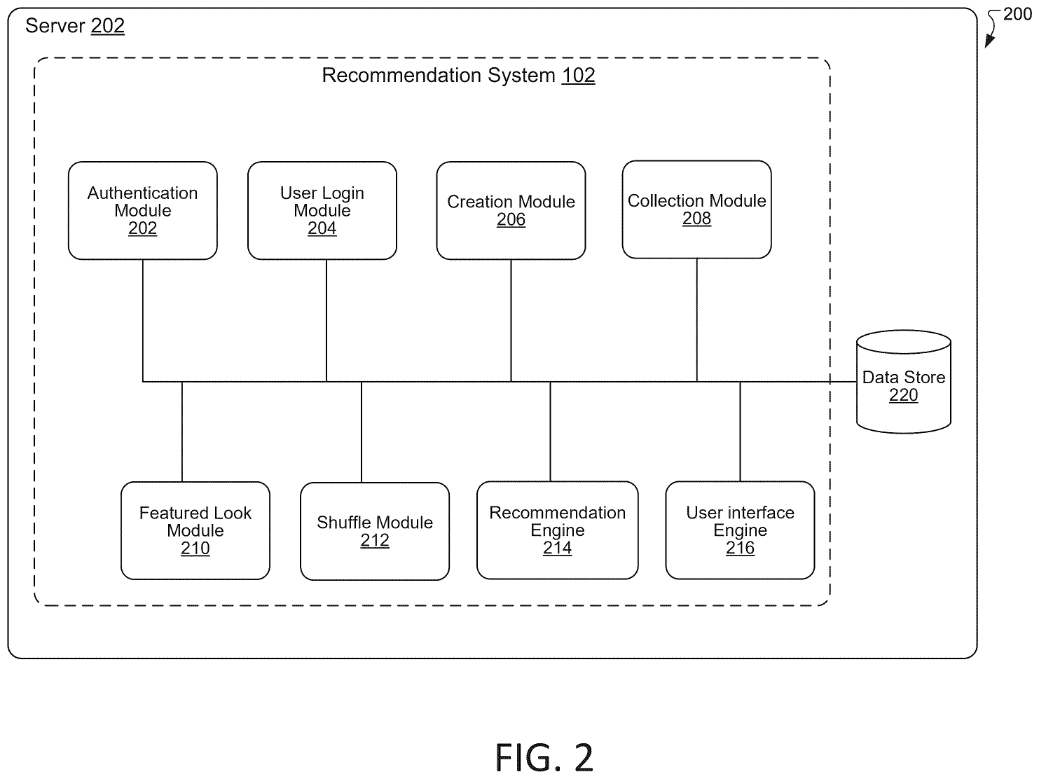

In some embodiments, the present system may also include a user interface tool. This interface tool can be used to allow users (e.g., editors, publishers, etc.) to create and manage the stores or allow users (e.g., developers, system architects) to configure, deploy, and manage applications, in an interactive, efficient, and flexible manner. This tool may further be designed to match the look and feel of other modules of the proposed system to improve user experience. The user interface tools and other modules/engines/tools will be described in detail below in FIG. 2.

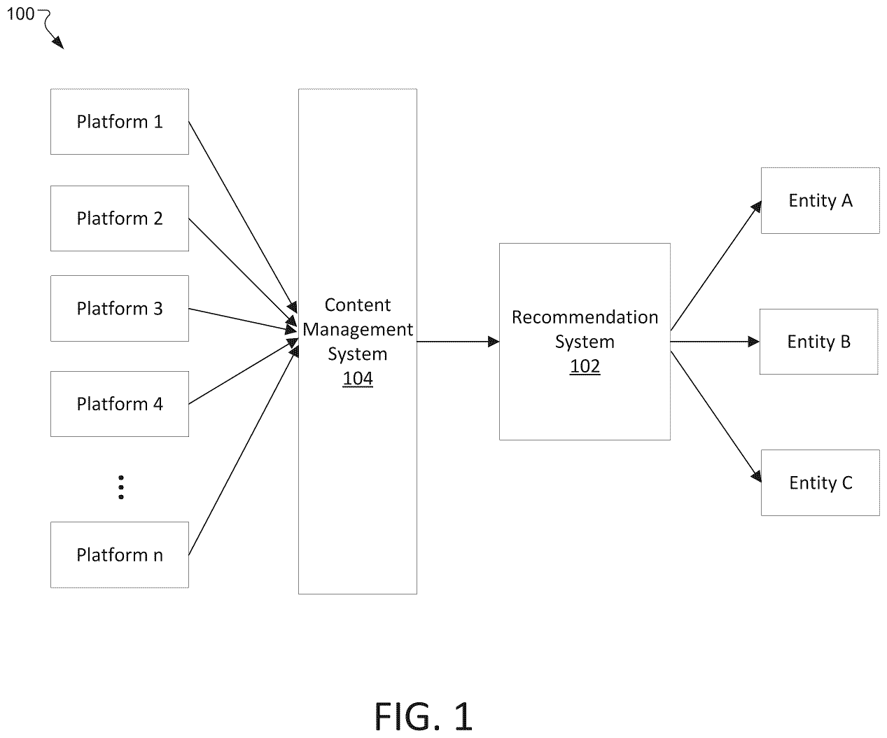

FIG. 1 illustrates an exemplary block diagram 100 of the overall architecture of the present system. As depicted, a recommendation system 102 is strategically positioned between a content management system (CMS) 104 and multiple downstream entities such as A, B, and C. This configuration allows recommendation system 102 to act as an intelligent intermediary to receive content feed received from CMS 104, process the content feed, and generate tailored recommendations for each entity. In some embodiments, the entities can be stores A, B, and C or similar digital platforms. The generated recommendations can include suggested products, content layouts, or promotional configurations, helping to automate and optimize the creation and management of stores A, B, and C.

CMS 104 is software that allows users to create, manage, store, and modify digital content. In some embodiments, CMS 104 may include a data warehouse to manage the product data ingested from retailers, for example, via affiliate platforms.

In some embodiments, platforms 1, 2, . . . n may include a variety of affiliate platforms such as Impact®, Awin®, Rakuten®, Partnerize®, CJ©, ShareASale®, etc. An affiliate platform allows brands and publishers to partner with each other and promote products or services. A publisher (e.g., influencers, content creators) has the store created with affiliate links. When a customer makes a purchase through a unique affiliate link, the brand/company gains customers, and the publisher gets rewarded for driving sales.

In some embodiments, CMS 104 may aggregate the data, including product information, pricing, brand data, affiliate links, etc., into a structured format and store the data in the data warehouse. Recommendation system 102 deployed between platforms/CMS 104 and stores may search and generate content recommendations using the structured content to help choose appropriate products (e.g., based on identifying trends), create valuable content that resonates with user needs, and provide useful insights for store management.

Advantageously, the present system may establish an authentication model to provide security protection and balance workflow efficiency. The present system may create a sandbox environment (e.g., a temporary, reviewable version of a store) to be shared with a publisher for review before the store becomes live, thereby providing flexibility and improving user experience. The present system may also monitor various changes and adapt the store creation and management processes to reflect the changes in real time. For example, the present system may create, update, and delete collections, featured looks, etc.; add and remove items to modules; add similar items, etc.

The present system also enables fine-grained control over product display details by modifying product details such as title, brand, retailer, description, original price, sale price, thumbnail image, etc. In some embodiments, the present system may apply these updates only to the store being built, but will not modify the actual feed data received from CMS 104. For example, the descriptions and logos are added or edited only when needed. That is, the updates/edits are localized to the store being built, preserving the integrity of the master data feed managed by CMS 104. This ensures that the user requirements for store creation are met without compromising the accuracy of the original feed data.

The present system includes one or more user-friendly interfaces for streamlining operations. For example, the present system may allow assets (e.g., hero images, store descriptions, collection descriptions) to be uploaded, replaced, and/or stored via graphic user interfaces (GUIs). The GUIs can also be used for customizing store elements, such as colors and fonts. Moreover, the AI-based recommendation system described herein also supports smart content recommendations, for example, allowing similar items to be prompted within an item through a GUI display when a text, image, or other type of search is conducted.

In some embodiments, the present system may include one or more modules tailored to specific use cohorts. While the present system (e.g., recommendation system 102) supports local modifications to product details as mentioned above, in some other embodiments, recommendation system 102 may support edits to CMS 104. CMS 104 is the source of truth for feed information. One or more GUIs may be deployed on top of CMS 104 to control feed integrity. In such scenarios, the present system allows global edits to key product data such as retailers, brands, descriptions, images, logos, etc. GUIs deployed on top of CMS 104 in such scenarios provide controlled, traceable access to core feed information, ensuring centralized data governance while offering flexibility for brand-level updates.

As mentioned above, the present disclosure is applicable in various fields for various data creation and management. For example, in the context of cloud-based application systems, the entities can be deployment environments A, B, and C, and the recommendation system 102 operating between the CMS 104 and multiple deployment environments can intelligently assist developers in setting up, configuring, and managing microservices-based applications by recommending compatible components, optimizing infrastructure configurations, and integrating monitoring and security tools. CMS 104 may act as a central repository for application metadata, sourcing information from platforms 1, 2, . . . n. The metadata may include metadata for microservices, container images, infrastructure templates, and dependency information, and platforms 1, 2, . . . n may include external service registries, infrastructure tools, and third-party APIs. Developers can use the system to streamline deployment workflows, preview configuration changes in sandboxed environments, and ensure that updates reflect real-time changes in dependencies and external services. The present system also includes graphical interfaces for configuring applications, customizing deployment pipelines, and visualizing performance data.

When generating deployment and configuration recommendations, the present system (e.g., recommendation system 102) may provide actionable insights to optimize deployment strategies or reduce configuration errors, thereby enhancing application performance, reliability, and maintainability. The present system may also offer a sandboxed staging environment where configuration changes and deployments can be previewed before being pushed to production, improving safety and user confidence. Moreover, the present system may monitor changes to dependencies, APIs, or performance metrics and automatically update or recommend updates to deployment configurations in real time.

In some embodiments, upon the detection of a configuration change, the present system may collect additional data and automatically update the deployment. For example, if a change in an external API behavior (e.g., a sudden spike in latency or an abnormal increase in error rates) is detected, the present system may automatically collect additional telemetry data such as detailed logs, request payloads, and response headers related to the affected API. This data is analyzed in the sandboxed staging environment to simulate and validate potential configuration updates (e.g., adjusting timeouts, retrying policies, or switching to a fallback API version). The present system may then apply the updated configuration to the deployment environment, improving resilience while avoiding unnecessary overhead during normal operation.

The present system may modify configuration metadata, such as container version tags, environment variables, resource limits, network settings, or logging parameters, within the scope of the active deployment. For example, temporary overrides may be introduced to fine-tune deployments for a specific workload without impacting global configurations, preserving consistency across environments. Unlike traditional systems that require manual intervention, the present system can automatically isolate or temporarily block a problematic API experiencing unbalanced workloads, eliminating the need for administrator involvement.

### Recommendation System

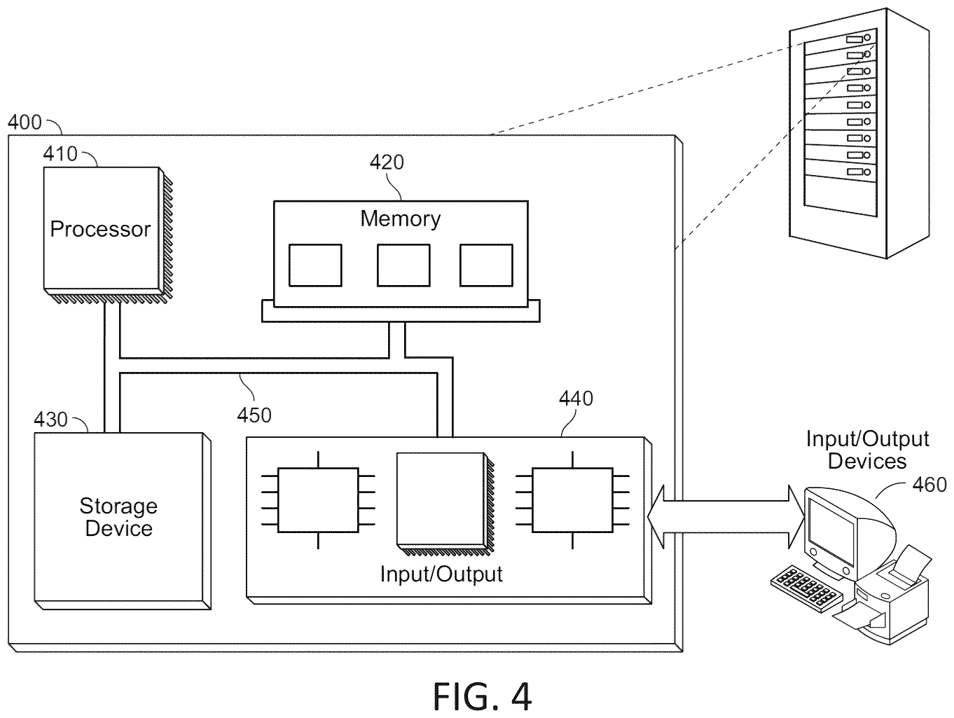

FIG. 2 illustrates exemplary components of the recommendation system described herein, e.g., recommendation system 102 in FIG. 1. In some embodiments, recommendation system 102 may be implemented on a computing environment including one or more servers, cloud servers, or other computer systems. In the illustrated embodiment, a server or computer system 202 includes a recommendation system 102 and a data store 220. Server or computer system 202 may include additional components, for example, computer processing units (CPUs), graphical processing units (GPUs), memory, external ports and connections, peripherals, power supplies, etc., required for the operation described herein. An example computer system will be described below in FIG. 4.

In some embodiments, recommendation system 102 includes an authentication module 202, a user login module 204, a creation module 206, a collection module 208, a featured look module 210, a shuffle module 212, a recommendation engine 214, and a user interface engine 216. Each module/engine can be implemented in hardware, software, or a combination thereof. In some embodiments, recommendation system 102 may include only a subset of the aforementioned modules/engines or include at least one of the aforementioned modules/engines. Additional modules/engines may be present on other servers or computer systems communicatively coupled to server 202. All possible permutations and combinations, including the ones described above, are within the spirit and the scope of this disclosure.

In some embodiments, each module/engine of recommendation system 102 may store the data used and generated in performing the functionalities described herein in data store 220. Data store 220 may be categorized in different libraries (not shown). Each library stores one or more types of data used in implementing the methods described herein. By way of example and not limitation, each library can be a hard disk drive (HDD), a solid-state drive (SSD), a memory bank, etc., to which other components of server 202 have read and write access.

FIG. 2 is described in the context of product recommendation for brevity and clarity; however, it should be noted that the system and approach described in this figure are also applicable to other types of recommendations and other types of data creation and management.

### Authentication and Store Creation

Authentication module 202 of recommendation system 102 may verify user identities and grant data access to the verified users. In some embodiments, authentication module 202 may establish user permissions/roles for individual users and verify user identities based on the user permissions.

In some embodiments, a user can be an administrator, an editor, and/or a viewer. When authentication module 202 determines that a user is an administrator, this user can create, update, and delete stores from a sandbox. A sandbox is an isolated, controlled environment used to run programs, test code, or evaluate system behavior without affecting the rest of the system or production infrastructure. The administrator is also permitted to approve or deny store movement, e.g., approve moving a store in a sandbox to production. When a user is determined to be an editor, authentication module 202 allows this user to create and update a store and all elements within the store. In some embodiments, a viewer may be an internal viewer or an external viewer. An internal/external viewer is allowed to view all staged stores that are identified as viewable internally/externally.

Once authentication module 202 confirms the user's identity, user login module 204 may manage the login process into recommendation system 102. In some embodiments, based on a login request from the user and the role and permissions associated with the user, user login module 204 may provide a customized landing page. The customized landing page is tailored to the specific needs and functions relevant to that user. For example, a publisher might be shown tools for managing storefronts or reviewing product recommendations, while an administrator might see dashboards for analytics, user management, or system configurations. This role-based customization ensures that users are presented with the most relevant tools and information upon logging in. By limiting access to specific portions that each user is authorized to see or modify, the present system reduces unnecessary use of computer network resources, thereby enhancing overall efficiency and strengthening security.

In particular, when an editor logs into recommendation system 102, user login module 204 may direct the editor to a landing page that includes one or more of a store status, a feed status, a store creation option, etc.

In some embodiments, a store status may be “in development,” “staged,” or “live.” When the editor requests the creation of a store (e.g., by clicking the store creation button) and recommendation system 102 has started to create the store upon the request, the store status of “in development” may be shown on the landing page. The “staged” status means the editor has pushed the store to the stage for internal review/approval and/or external review/approval. Once the store is in production, the landing page shows this status as “live.”

In some embodiments, the feed status in the landing page presented to the editor provides the latest refresh of feeds and serves as a freshness indicator to recommendation system 102. The landing page may also include a clickable button that allows the editor to initiate the store creation process.

Once the editor requests the creation of a store, creation module 206 may also be triggered to implement the store creation process. In some embodiments, creation module 206 may cooperate with other modules/engines of recommendation system 102 to help the editor add or select a publisher, name the store, upload a store image, determine a color and font theme, add, delete, update, and order modules, etc.

When creation module 206 starts to construct the store in a development environment, the store is in an “in development” status. When the store is ready to be shared for feedback, creation module 206 allows the editor to push the store to stage (e.g., via a GUI). When the store status changes to “staged,” the store includes a link that is available to share internally or externally for receiving feedback. Once the store has been reviewed and approved, creation module 206 will then allow the editor to push the store “live” for launch or production.

### Store Content Creation

During the construction of the store, collection module 208 may work with creation module 206 to create collections for the store. A collection may include information that is gathered for a specific purpose, for example, a collection of products in the same category, a collection of hero images, a collection of on-sale products, etc. A hero image is a large, featured image (or series of images) prominently displayed on the homepage of an online store, such as banner images that visually highlight featured content. In some embodiments, collection module 208 may associate each created collection with one or more stores.

In some embodiments, collection module 208 may allow a user to name a collection and optionally select a tag for the collection. For example, the tag can be trending, top 10, popular, on sale, best sellers, free shipping, selling fast, hot item, etc. In some embodiments, collection module 208 may also communicate with recommendation engine 214 to automatically generate a tag through AI-based analysis.

A hero image is typically displayed on the homepage of an online store. Similar to the landing page, the hero image creates a strong first impression for a brand, making it an important part of creating the store. If a hero image is available (e.g., selectable via a GUI), collection module 208 may upload the image for the user. However, if no hero image is available, collection module 208 may generate a hero image using AI analysis based on the store image(s), store name, and collection name.

Collection module 208 combined with recommendation engine 214 may perform AI analysis to select items for the collection from a product universe (e.g., a product database). In some embodiments, a set of products may be recommended based on the hero image and/or collection name. In other embodiments, the products may be recommended based on user input (e.g., an editor's prompt). The AI analysis may incorporate multi-modal learning models that process both visual and textual inputs to derive relevance scores for items in relation to a given collection. For example, machine learning models (e.g., convolutional neural networks (CNNs) or vision transformers (ViTs)) may be employed to analyze hero images to extract visual features such as color schemes, textures, and patterns. Simultaneously, natural language processing (NLP) models (e.g., fine-tuned transformers) may be used to process the collection name(s) or user prompt(s) to infer semantic context, thematic keywords, or stylistic intent. These multimodal features are combined using embedding fusion techniques and compared against the metadata and visual signatures of products in the database to generate recommended items in the collection. For example, collection module 208 may cooperate with other modules (e.g., 206, 210, 214) to create a collection of 20 items that align with a specific theme, such as the “Western Gothic” theme from a specific store. The collection may include a mix of apparel and home decoration items, with each item priced under $100 to meet criteria (e.g., aesthetic and budget criteria) defined by the editor. The AI analysis will be further detailed below with reference to the description of recommendation engine 214.

In some embodiments, in response to an editor selecting an item of a collection, collection module 208 and recommendation engine 214 may perform AI analysis (e.g., similarity-based search and retrieval) to determine and recommend items that fit into the collection based on one or more of the items selected, the hero image, the collection title, or user prompt. Here, the AI analysis may include a vector similarity search using a cosine or Euclidean distance in a feature space derived from pre-trained embedding models. For example, the similarity between the selected items and other potential recommendations may be evaluated based on shared attributes such as style tags, material, color palette, or category metadata. Collection module 208 may then instruct user interface engine 216 to generate one or more GUIs for the user (e.g., editor) to provide feedback on the item selection results. The GUIs may also allow the user to filter the results by brand, retailer, category, price, etc.

In some embodiments, collection module 208 together with other modules of recommendation system 102 may also use AI approaches to automatically crop and scale the thumbnail and the product images, as well as cleanse various store-related information such as product names, brands, retailers, and descriptions. For example, collection module 208 may employ image preprocessing models using computer vision techniques for tasks such as automatic cropping, scaling, etc., and NLP-based data cleansing modules and/or rule-based contextual language models to standardize and sanitize textual data. As a result, the stores may have a universal, cohesive, and professional look regardless of variations in source data.

Based on AI analysis, collection module 208 may recommend similar items for each item in a collection. Collection module 208 may allow a user (e.g., editor) to add the recommended items to the collection if the user determines that a recommended item fits the collection. In some embodiments, collection module 208 may flag items with a sponsorship marker (e.g., a badge or banner) if the collection is sponsored. In some embodiments, collection module 208 may allow a user to accept or reject any recommendations (e.g., tags, products) that are automatically created based on AI analysis, ensuring human oversight while benefiting from automated intelligence.

Featured look module 210 is responsible for creating featured look(s) for a store. A featured look may include products, images, and other information that attract more consumers to a store, increase visibility, and drive traffic to specific items or categories. Each featured look can be associated with one or more stores.

In some embodiments, featured look module 210 may name a featured look, upload an image or vertical video for the featured look, and tag items in the featured look. The image can be collage style or a single picture. A vertical video is a video created for viewing in portrait mode, which generally should be short when used to create a featured look. In some embodiments, featured look module 210 in combination with other modules of recommendation system 102 generates a tag for the featured look using one or more AI approaches. Featured look module 210 may also apply a sponsored flag if the featured look is sponsored.

In some embodiments, shuffle module 212 may be used to provide dynamic content by creating a variety of shuffles (e.g., top 10 shuffles, other thematic item lists) based on items sourced from a product database. The purpose of the shuffle is to offer randomized or semi-randomized item sets that are still contextually relevant and visually cohesive. For example, when a user (e.g., editor) selects an item, the AI-powered shuffle module 212 may recommend items based on the item selected, the hero image, and the collection name. In some embodiments, the shuffle module 212 may apply collaborative filtering, content-based filtering, or hybrid recommendation techniques to generate shuffle results that maintain stylistic consistency and relevance. Like collections and featured looks, shuffles can also be flagged as sponsored. Moreover, each shuffle can be associated with one or more stores, allowing content to be reused or recontextualized across different store environments with appropriate tagging and visual presentation.

### AI-Based Search and Recommendation

As discussed above, the present system supports AI-powered operations such as tagging items, recommending hero images, finding similar items, etc., in creating a collection, a featured look, and a shuffle. A recommendation engine 214 may cooperate with different modules (e.g., 206, 208, 210, and 212) of recommendation system 102 to perform these AI-based operations.

In some embodiments, recommendation engine 214 may be powered by one or more AI models including a customized transformer-based multi-modal embedding model. In some embodiments, this model leverages transformer architecture and deep learning techniques (e.g., NLP) to understand complex relationships within data. With multi-modality, the model is capable of processing and learning from various types of input data. Moreover, the AI model(s) may be specialized for specific operating domains (e.g., fashion, home goods, etc.) and tailored toward specific catalog data for improving accuracy and relevance.

Upon receiving a user input, recommendation engine 214 may encode it into a high-dimensional embedding (e.g., a vector of numerical representations) using the transformer-based multi-modal embedding model. A high-dimensional embedding is a mathematical representation of data in the form of a vector with many dimensions (e.g., hundreds or thousands of numerical values), where each value/feature in the vector encodes some aspect of the input data in a numerical format that the AI model can process. This embedding transforms complex, unstructured input into a structured numerical vector to capture the semantic meaning, relationships, or contextual similarities between different inputs. The high-dimensional embeddings enable powerful operations such as search, recommendation, and classification.

In some embodiments, the user input can be prompt(s) from a user (e.g., an editor) in the form of one or more of an image, a text blob, a categorical filter, a voice input, a video input, etc. A categorical filter is a type of filter that allows the refinement of results based on discrete, predefined categories or labels. Here, the categorical filter can be based on brand, retailer, price, etc. Recommendation engine 214 may convert the user input into a vector representation in a shared space, where semantically or visually similar items are close together. These embeddings are then used for downstream tasks such as search and retrieval (e.g., similar items), recommendations, matching prompts to products, etc.

As an extension to the raw input (e.g., text prompts) from a user, in some embodiments, recommendation engine 214 may be configured to search and extract relevant information from online sources to complement the user input. For example, if the input prompt includes the name of a celebrity or a TV show, recommendation engine 214 can fetch contextual information about that celebrity or show (e.g., the dressing style of people in the show/movie) and append that information to the user's prompt before encoding the prompt into a high dimensional embedding. In other words, the contextual information is also incorporated into the embedding computation.

Once an embedding is generated, recommendation engine 214 may perform hierarchical searches to refine the search results until a final result is obtained. Given an embedding being generated, recommendation engine 214 may perform the first search by using the embedding to search over pre-computed embeddings of the product universe (e.g., product database) to obtain the most similar items. In some embodiments, recommendation engine 214 may apply an exact or approximate nearest-neighbor-based approach to find a set of most similar items. Recommendation engine 214 may also use the user-provided search filters (e.g. price, brand, etc.) to narrow the embedding search space or further refine the set of items (e.g., reducing to Top k items). Recommendation engine 214 may instruct user interface engine 216 to display similar items to the user (e.g., editor).

Recommendation engine 214 may then perform the second search on similar items to determine the best matches. In some embodiments, based on the type and number of inputs provided by a user (e.g., editor), recommendation engine 214 may employ one or more algorithms to determine the best results including a subset of items and return the best matches to the user. In some embodiments, recommendation engine 214 may perform the second search to determine the matches based on user intent captured from the type, number, semantic meaning, interaction behavior (e.g., time spent on items), contextual metadata (e.g., location) associated with the user inputs.

In some embodiments, recommendation engine 214 may perform image-to-image retrieval. In this scenario, the user input is an image prompt. Recommendation engine 214 converts the input image prompt into an embedding and searches over the image embeddings of the catalog data. In some embodiments, recommendation engine 214 may perform image-to-text retrieval. In this scenario, the user input is an image prompt. Recommendation engine 214 converts the input image prompt into an embedding and searches over the text embeddings of the catalog data. In some embodiments, recommendation engine 214 may perform text-to-text retrieval. In this scenario, the user input is a text prompt. Recommendation engine 214 converts the input text prompt into an embedding and searches over the text embeddings of the catalog data. In some embodiments, recommendation engine 214 may perform text-to-image retrieval. In this scenario, the user input is a text prompt. Recommendation engine 214 converts the input text prompt into an embedding and searches over the image embeddings of the catalog data.

Given the best matches being generated, recommendation engine 214 may perform the third search to obtain a final search result. In some embodiments, recommendation engine 214 may apply a parameterized algorithm to determine the final set of best results. The parameterized algorithm uses one or more tunable parameters (e.g., weightings, thresholds, ranking criteria, user-defined filters, etc.) to influence the input processing and output generation. For example, when refining recommended items, a parameterized algorithm can be used to balance how closely an item matches the semantic meaning of a user's prompt, how popular the item is in recent trends, and whether the item fits a user-defined preference. By adjusting the parameters (e.g., giving 40% weight to semantic similarity, 20% to popularity, and 40% to preference), the present system can dynamically return a result set tailored to different priorities or use cases. In some embodiments, recommendation engine 214 may employ this algorithm in a continuous learning environment, meaning the search and recommendation process will learn from the feedback given by the users/editors over time. Continuing with the above example, based on the user feedback, the present system may adjust the weight given to the user preference and update the recommended items.

When a store is being created or managed, especially when a user (e.g., editor) is browsing similar items suggested by AI-powered modules or items returned based on an image prompt, the user may be presented options (e.g., buttons, comment bubbles) to give feedback about each item result to the AI model used by recommendation engine 214. For example, by a simple “Thumbs up/Thumbs down” selection, recommendation engine 214 allows the user to provide feedback to each searched item, regardless of whether the item is relevant to what the user was looking for. If the user leaves a “thumbs down,” recommendation engine 214 may also instruct user interface engine 216 to generate a comment area for the user to explan. Over time, the AI model employed by recommendation engine 214 may learn from all the collected feedback to improve its search results and recommendations, thereby resulting in a continuously improving system.

In some embodiments, recommendation engine 214 may also improve the search and recommendation results by leveraging ratings and reviews of various products. When such ratings are available in the feed, by assigning more weights to higher-rated products, recommendation engine 214 may improve the accuracy and relevancy of the final result lists returned to the user.

Additionally, recommendation engine 214 can be configured to deliver dynamic search and recommendation results. For example, suppose an editor searches for a “red party dress” and recommendation engine 214 retrieves the top five matches for that query. If the editor likes the first search result (e.g., the editor selects it with a click), recommendation engine 214 may then issue a second query to its AI model to retrieve the rest of the results based on the original input as well as the selected item. In other words, recommendation engine 214 now retrieves the next four results based on similarity to the editor's original input, as well as the similarity to the top search result which was found to be relevant and useful by the editor. This requires the employment and adjustment of a complex search algorithm as discussed above. In this way, the dynamic search/recommendation engine, i.e., recommendation engine 214, can continuously update its results based on the editor's actions on retrieved items.

### Content Display

In some embodiments, user interface engine 216 may provide data to other modules of recommendation system 102 to perform the functionalities described herein. User interface engine 216 may also communicate with other modules of recommendation system 102 to generate and transmit graphic data to a user device for displaying relevant information to users (e.g., editors or content creators) and allowing the users to interact with the system through GUIs. By enabling intuitive visual interaction, user interface engine 216 enhances user experience and supports efficient and effective content creation and management workflows.

### Flow Chart

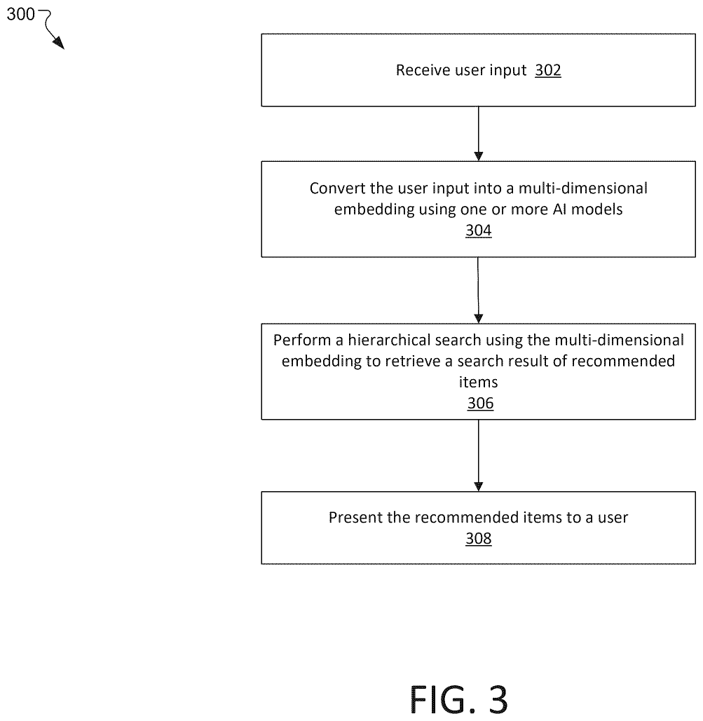

FIG. 3 illustrates an exemplary flowchart 300 of generating content recommendations using AI models, according to some embodiments. In some embodiments, various components of recommendation system 102 along with other system components (e.g., platforms, entities) may work together to implement the operations of flowchart 300.

At step 302, user input is received, for example, from an editor creating an online store. The user input can be an image, a text input, a categorical filter, a voice input, etc. At step 304, the user input is converted into a high-dimensional embedding using one or more AI models. In some embodiments, the AI models may include a transformer-based multi-modal embedding model. The high-dimensional embedding may be a multi-dimensional vector. The high-dimensional embedding can be used to represent the semantic meaning, relationships, or contextual similarities between different user inputs, and then used by a transformer-based multi-modal embedding model to dynamically generate item recommendations.

At step 306, a hierarchical search is performed using the high-dimensional embedding to retrieve and refine a search result of recommended items. In some embodiments, performing the hierarchical search includes performing a first search on a database to retrieve a set of content items based on measuring similarity between the multi-dimensional embedding and embeddings of items stored in the database, refining the set of content items by performing a second search on the set of content items based on at least one of a type of the user input or a number of the user input, and performing a third search on the refined content items to determine the search result of recommended items using a parameterized algorithm operating in a continuous learning environment. The hierarchical search can include one or more of an image-to-image retrieval, an image-to-text retrieval, a text-to-image retrieval, or a text-to-text retrieval. At step 308, the recommended items are presented to the user via one or more GUIs.

As discussed above, this method can also be applied in different technical fields. For example, the present system may receive user input for configuring a new cloud environment from a DevOps engineer. The user input can include a configuration file, a plain text description (e.g., “deploy a high-availability web app with auto-scaling”), a categorical filter (e.g., cloud provider=AWS, cost<$100/month), or even a voice command. This user input can be converted into a multi-dimensional vector to encode the semantic intent and constraints to drive dynamic cloud configuration recommendations.

The hierarchical search in this scenario can include: (i) a first search to retrieve candidate configurations by matching the user's embedding to embeddings of stored templates, (ii) a second search to refine these results based on the type of input (e.g., configuration script vs. text command) and the level of specificity provided, and (iii) a third search that applies a parameterized optimization algorithm, by taking into account current usage trends, cost models, or previous user feedback, to return the best-matched configuration. The present system may support retrieval modes such as text-to-template, voice-to-template, or code-to-code similarity. The recommended deployment configuration is presented to the user via an interactive GUI that may also allow editing, approval, and one-click deployment.

### Computer Implementation

In some examples, some or all of the processing described above can be carried out on a personal computing device, on one or more centralized computing devices, or via cloud-based processing by one or more servers. Some types of processing can occur on one device and other types of processing can occur on another device. Some or all of the data described above can be stored on a personal computing device, in data storage hosted on one or more centralized computing devices, and/or via cloud-based storage. Some data can be stored in one location and other data can be stored in another location. In some examples, quantum computing can be used, and/or functional programming languages can be used. Electrical memory, such as flash-based memory, can be used.

FIG. 4 is a block diagram of an example computer system 400 that may be used in implementing the technology described herein. General-purpose computers, network appliances, mobile devices, or other electronic systems may also include at least portions of the system 400. The system 400 includes a processor 410, a memory 420, a storage device 430, and an input/output device 440. Each of the components 410, 420, 430, and 440 may be interconnected, for example, using a system bus 450. The processor 410 is capable of processing instructions for execution within the system 400. In some implementations, the processor 410 is single-threaded. In some implementations, the processor 410 is a multi-threaded processor. The processor 410 is capable of processing instructions stored in the memory 420 or on the storage device 430.

Memory 420 stores information within the system 400. In some implementations, the memory 420 is a non-transitory computer-readable medium. In some implementations, the memory 420 is a volatile memory unit. In some implementations, the memory 420 is a non-volatile memory unit.

The storage device 430 is capable of providing mass storage for the system 400. In some implementations, the storage device 430 is a non-transitory computer-readable medium. In various implementations, the storage device 430 may include, for example, a hard disk device, an optical disk device, a solid-state drive, a flash drive, or some other large-capacity storage device. For example, the storage device may store long-term data (e.g., database data, file system data, etc.). The input/output device 440 provides input/output operations for the system 400. In some implementations, the input/output device 440 may include one or more network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer, and display devices 460. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, executable code, or other instructions stored in a non-transitory computer-readable medium. The storage device 430 may be implemented in a distributed way over a network, such as a server farm or a set of widely distributed servers, or may be implemented in a single computing device.

Although an example processing system has been described in FIG. 4, embodiments of the subject matter, functional operations, and processes described in this specification can be implemented in other types of digital electronic circuitry, in tangibly embodied computer software or firmware, in computer hardware, including the structures disclosed in this specification and their structural equivalents, or combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to a suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special-purpose logic circuitry, e.g., an FPGA (field programmable gate array) or an ASIC (application-specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program can include, by way of example, general or special purpose microprocessors or both, or any other kind of central processing unit. Generally, a central processing unit will receive instructions and data from a read-only memory, a random access memory, or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer-readable media suitable for storing computer program instructions and data include all forms of non-volatile memory, media, and memory devices, including way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special-purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship between client and server arises by virtue of computer programs running on the respective computers and having a client-server relationship with each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims

### Terminology

The phraseology and terminology used herein are for the purpose of description and should not be regarded as limiting.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Each numerical value presented herein, for example, in a table, a chart, or a graph, is contemplated to represent a minimum value or a maximum value in a range for a corresponding parameter. Accordingly, when added to the claims, the numerical value provides express support for claiming the range, which may lie above or below the numerical value, in accordance with the teachings herein. Absent inclusion in the claims, each numerical value presented herein is not to be considered limiting in any regard.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. The features and functions of the various embodiments may be arranged in various combinations and permutations, and all are considered to be within the scope of the disclosed invention. Accordingly, the described embodiments are to be considered in all respects as only illustrative and not restrictive. Furthermore, the configurations, materials, and dimensions described herein are intended as illustrative and in no way limiting. Similarly, although physical explanations have been provided for explanatory purposes, there is no intent to be bound by any particular theory or mechanism, or to limit the claims in accordance therewith.

What is claimed is:

1. A computer-implemented method comprising:
receiving user input at a computing system comprising a processor and a memory;
converting, by the processor, the user input into a high-dimensional embedding using one or more AI models;
performing, by the processor, a hierarchical search using the high-dimensional embedding to retrieve and refine a search result of recommended items; and
presenting, by the processor, the recommended items to a user.

2. The method of claim 1, wherein the user input includes one or more of an image, a text input, a categorical filter, or a voice input.

3. The method of claim 2, wherein performing the hierarchical search comprises:
performing a first search on a database to retrieve a set of content items based on measuring similarity between the high-dimensional embedding and embeddings of items stored in the database;
refining the set of content items by performing a second search on the set of content items based on at least one of a type of the user input or a number of the user input; and
performing a third search on the refined content items to determine the search result of recommended items using a parameterized algorithm operating in a continuous learning environment.

4. The method of claim 3, wherein the hierarchical search comprise one or more of an image-to-image retrieval, an image-to-text retrieval, a text-to-image retrieval, or a text-to-text retrieval.

5. The method of claim 1, wherein the one or more AI models include a customized transformer-based multi-modal embedding model.

6. The method of claim 1, further comprising:
identifying contextual information associated with the user input; and
appending the identified contextual information to the user input,
wherein both the user input and the appended information are converted into the high-dimensional embedding.

7. The method of claim 1, wherein the search result of recommended items includes a first item and a second item, and the first item is presented to the user before the second item, and the method further comprising:
dynamically updating the second item based on user interaction with the first item.

8. The method of claim 1, further comprising:
determining one or more user permissions and roles for the user; and
verifying an identity of the user based on the user permissions and roles.

9. The method of claim 8, further comprising:
providing a customized landing page to the user based on the user permissions through a graphical user interface; and
adding one or more interactive elements in the graphical user interface to receive the user input from the user.

10. The method of claim 1, further comprising creating a plurality of shuffles to provide dynamic content.

11. A system comprising:
a processor; and
a memory in communication with the processor and comprising instructions which, when executed by the processor, program the processor to:
receive user input;
convert the user input into a high-dimensional embedding using one or more AI models;
perform a hierarchical search using the high-dimensional embedding to retrieve and refine a search result of recommended items; and
present the recommended items to a user.

12. The system of claim 11, wherein the user input includes one or more of an image, a text input, a categorical filter, or a voice input.

13. The system of claim 12, wherein, to perform the hierarchical search, the instructions further program the processor to:
perform a first search on a database to retrieve a set of content items based on measuring similarity between the high-dimensional embedding and embeddings of items stored in the database;
refine the set of content items by performing a second search on the set of content items based on at least one of a type of the user input or a number of the user input; and
perform a third search on the refined content items to determine the search result of recommended items using a parameterized algorithm operating in a continuous learning environment.

14. The system of claim 13, wherein the hierarchical search comprise one or more of an image-to-image retrieval, an image-to-text retrieval, a text-to-image retrieval, or a text-to-text retrieval.

15. The system of claim 11, wherein the one or more AI models include a customized transformer-based multi-modal embedding model.

16. The system of claim 11, wherein the instructions further program the processor to:
identify contextual information associated with the user input; and
append the identified contextual information to the user input,
wherein both the user input and the appended information are converted into the high-dimensional embedding.

17. The system of claim 11, wherein the search result of recommended items includes a first item and a second item, and the first item is presented to the user before the second item, and the instructions further program the processor to:
dynamically update the second item based on user interaction with the first item.

18. The system of claim 11, wherein the instructions further program the processor to:
determine one or more user permissions and roles for the user; and
verify an identity of the user based on the user permissions and roles.

19. The system of claim 18, wherein the instructions further program the processor to:
provide a customized landing page to the user based on the user permissions through a graphical user interface; and
add one or more interactive elements in the graphical user interface to receive the user input from the user.

20. A computer program product comprising a non-transitory computer-readable medium having computer readable program code stored thereon, the computer readable program code configured to:
receive user input;
convert the user input into a high-dimensional embedding using one or more AI models;
perform a hierarchical search using the high-dimensional embedding to retrieve and refine a search result of recommended items; and
present the recommended items to a user.
